(19) United States
(12) Patent Application Publication
(10) Pub. No.: US 2009/0218928 A1
(43) Pub. Date: Sep. 3, 2009

(54) ELECTRODE, METHOD FOR PRODUCING ELECTRODE, AND COLD-CATHODE FLUORESCENT LAMP

(75) Inventors: Toshikazu Sugimura, Tokyo (JP); Hitoshi Hata, Tokyo (JP); Harushige Sugimura, Tokyo (JP); Satoshi Tamura, Tokyo (JP); Kunio Takahashi, Fukushima (JP); Kazuhiko Yamagishi, Fukushima (JP); Hiroaki Nishikata, Fukushima (JP)

Correspondence Address: YOUNG & THOMPSON, 209 Madison Street, Suite 500, ALEXANDRIA, VA, 22314, US

(73) Assignee: NEC LIGHTING, LTD., Tokyo (JP)

(21) Appl. No.: 12/091,861

(22) PCT Filed: Oct. 25, 2006
(86) PCT No.: PCT/JP2006/321246

§ 371 Date: Mar. 26, 2009

(30) Foreign Application Priority Data
Oct. 26, 2005 (JP) 2005-311371

(51) Int. Cl. H01J 1/62; H01B 1/22; C22C 1/02

(52) U.S. Cl. 313/491; 252/513; 75/585

(57) ABSTRACT

Cylindrical electrodes (7) are arranged opposite to each other in an internal space (5) of a hermetically sealed glass tube (2) which is filled with a rare gas and a mercury gas. The cylindrical electrodes (7) is mainly composed of nickel (Ni), and one or both of yttrium (Y) and yttrium oxide (YOₓ) are dispersed in the cylindrical electrodes (7).

### TECHNICAL FIELD

The present invention relates to a cold-cathode fluorescent lamp, and particularly relates to an art for enhancing starting performance of a cold-cathode fluorescent lamp in a dark space.

### BACKGROUND ART

A general discharge lamp uses thermoelectrons, photoelectrons, electrons emitted by a high electric field, electrons included in cosmic rays of the natural world and the like as electrons (primary electrons) which trigger discharge. Among conventional discharge lamps, discharge lamps that use photoelectrons as the primary electrons are difficult or impossible to start (light) when installed in a space (dark space) in which external light is completely or substantially completely shut off. This is because even cosmic rays, not to mention photoelectrons, do not reach the discharge lamp.

Improvement in starting performance in the dark space is especially strongly required of a cold-cathode fluorescent lamp which is a kind of a discharge lamp for the following reason. Cold-cathode fluorescent lamps are widely used today as light sources for backlight units of liquid crystal display devices. The housing of a backlight unit generally has a hermetic structure. Accordingly, external light hardly reaches a cold-cathode fluorescent lamp installed in the housing. Specifically, the cold-cathode fluorescent lamps used as the light sources for backlight units are always installed in dark spaces.

Thus, conventionally, a film or a layer of a cesium compound which is a substance with a low work function (hereinafter, collectively described as “cesium compound layer”) is formed on the surface of electrodes to improve starting performance (see Japanese Patent Laid-Open No. 2001-15065).

However, there exists the following problem in forming a cesium compound layer on the surface of the electrode. Since a cesium compound is an alkali metal, the cesium compound reacts with mercury sealed in the discharge tube (glass tube) to form amalgam. As a result, mercury in the glass tube is exhausted, and the life of the lamp becomes short. When a cesium compound layer is formed on one of a pair of electrodes, the temperature of the electrode, while the lamp is being lit, becomes lower as compared with the temperature of other electrode. As a result, mercury sealed inside the glass tube exists only on the side of the electrode on which the cesium compound layer is formed, and lamp luminance becomes ununiform. Further, the cesium compound layer is formed by coating a liquid cesium compound on the outer peripheral surface of the electrode. However, it is difficult to coat the required amount of cesium compound uniformly on the outer peripheral surface of the electrode.

### DISCLOSURE OF THE INVENTION

The present invention is intended to solve the above described problems. An object of the present invention is to provide a cold-cathode fluorescent lamp capable of maintaining excellent starting performance for a long period.

The inventors of the present invention paid attention to yttrium (Y) in the course of earnest investigation to attain the above described object. In this respect, the electron emitting performance of the electrodes improved by utilizing yttrium are disclosed in Japanese Patent Laid-Open No. 9-360422, Japanese Patent Laid-Open No. 9-113908 and Japanese Patent Laid-Open No. 11-273533. However, the electrodes disclosed in these official gazettes only the electrodes in which yttrium layers or films were formed on their surfaces. As is obvious from the fact that sputtering resistance is strongly required of the electrodes of the discharge lamps, the electrodes are sputtered by collision of argon (Ar) and neon (Ne) while the lamp is being lit. Therefore, the yttrium layer or film formed on the electrode surfaces is lost by sputtering, and the effect of yttrium cannot be obtained continuously. Thus, the inventors of the present invention repeated further studies and completed the present invention.

An electrode of the present invention is an electrode used for a cold-cathode fluorescent lamp. The main component of the electrode of the present invention is nickel (Ni), and either yttrium (Y) or yttrium oxide (YOx), or both, is/are dispersed in the electrode of the present invention.

A method for manufacturing the electrode of the present invention includes either yttrium (Y) or yttrium oxide (YOx), or both, and nickel (Ni), and obtaining a nickel-base metal material in which either yttrium (Y) or yttrium oxide (YOx), or both, is/are dispersed, and machining the metal material into a desired shape.

The cold-cathode fluorescent lamp of the present invention includes the electrode of the above described present invention or an electrode produced according to the production method of the above described present invention.

The above described and other objects, features and advantages of the present invention will become apparent with reference to the following description and the accompanying drawings showing an example of the present invention.

### BRIEF DESCRIPTION OF THE DRAWINGS

FIG. 1 is a sectional view showing an example of an exemplary embodiment of a discharge lamp of the present invention;

FIG. 2 is a sectional view showing another example of an exemplary embodiment of the discharge lamp of the present invention; and

FIG. 3 is a sectional view showing an example of a conventional discharge lamp.

### BEST MODE FOR CARRYING OUT THE INVENTION

### Exemplary Embodiment 1

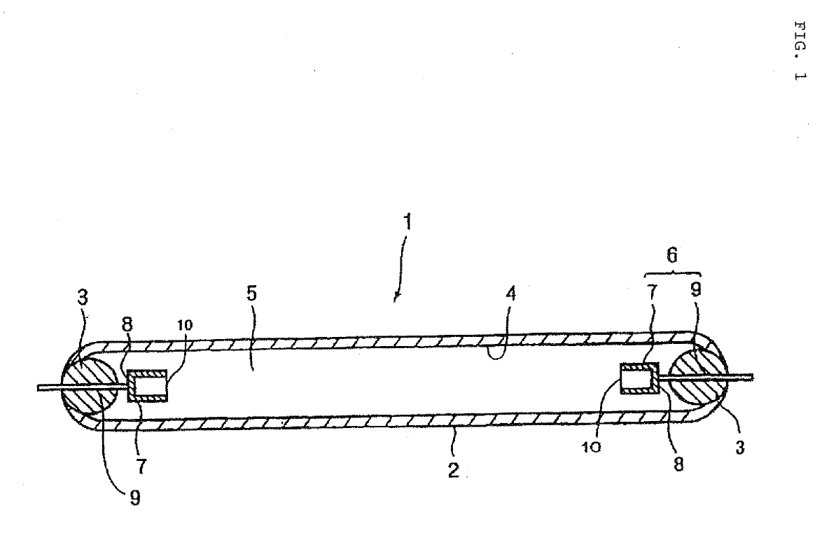

Hereinafter, one example of an exemplary embodiment of a cold-cathode fluorescent lamp of the present invention will be described in detail with reference to the drawings. FIG. 1 is a sectional view showing a schematic structure of cold-cathode fluorescent lamp 1 of this example.

Cold-cathode fluorescent lamp 1 includes glass tube 2 formed by borosilicate glass. Glass tube 2 is hermetically sealed by sealing glass (bead glass 3) at both ends. The outside diameter of glass tube 2 is within a range of 1.5 to 6.0 mm, preferably within a range of 1.5 to 5.0 mm. The material of glass tube 2 may be lead glass, soda glass, low lead glass or the like.

On inner wall surface 4 of glass tube 2, a phosphor layer not illustrated is provided over substantially the entire length of it. The phosphor forming the phosphor layer is properly selected from existing or new phosphors such as a halophosphate phosphor and a rare earth phosphor in accordance with the object and the purpose for using cold-cathode fluorescent lamp 1. Further, the phosphor layer can be formed by a phosphor made by mixing two or more kinds of phosphors.

Predetermined amounts of rare gas (argon gas, or mixture gas of argon gas and xenon gas, neon gas or the like) and mercury are sealed in internal space 5 of glass tube 2 enclosed by internal wall surface 4. Further, the inside of internal space 5 is decompressed to about one several tenths of atmospheric pressure.

A pair of electrode units 6 are provided at both ends in the longitudinal direction of glass tube 2. Each of electrode units 6 is configured by cylindrical electrode 7, and lead wire 9 joined to bottom surface portion 8 of cylindrical electrode 7. Cylindrical electrode 7 of each of electrode units 6 is disposed slightly inside from the end portion of internal space 5. Openings of each cylindrical electrode 7 are disposed in orientations opposite to each other. Each of lead wires 9 has its one end welded to bottom surface portion 8 of corresponding cylindrical electrode 7. The other end of the lead penetrates through bead glass 3 to be led outside of glass tube 2. Lead wire 9 is made of a conductive material (koval in this example) with the same or substantially the same thermal expansion coefficient as that of bead glass 3.

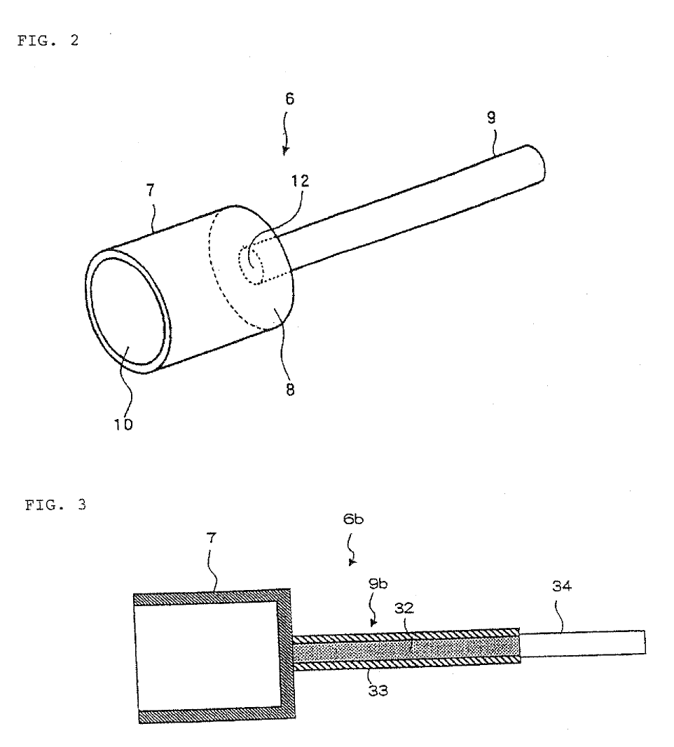

FIG. 2 is an enlarged perspective view of electrode unit 6 which is included in cold-cathode fluorescent lamp 1. Cylindrical electrode 7 configuring electrode unit 6 includes a cup shape with opening 10 formed at one side in the longitudinal direction and is closed at the other side by bottom surface portion 8. Cylindrical electrode 7 is formed into the illustrated shape by pressing or by header-processing a plate-shaped or linear (wire-shaped) metal material.

The above described metal material is a nickel base metal material in which yttrium oxide (YOx) is dispersed. More specifically, it is a metal material formed by melting and dissolving the mixture powder prepared by mixing yttrium oxide powder and nickel (Ni) powder and integrating them. The metal material includes a mixture ratio of 99.3 weight % of nickel (including 0.01% or less of cobalt), 0.55 weight % of yttrium oxide, 0.1 weight % of manganese, and 0.05 weight % of impurities (carbon, silicon, copper, sulfur, magnesium and iron). Cylindrical electrode 7 made of the metal material also has a composition substantially similar to the above. Yttrium oxide is selectively precipitated in the crystal grain boundary of the metal material due to its nature.

Since cylindrical electrode 7 has the above described composition, the starting performance of cold-cathode fluorescent lamp 1 of this example is excellent even in a dark space. More specifically, electrons are always emitted from the yttrium oxide dispersed in cylindrical electrode 7. Therefore, discharge is started substantially simultaneously with the application of voltage to cylindrical electrode 7 (cold-cathode fluorescent lamp 1 is lit) by using the electrons emitted from the yttrium oxide as the primary electrons. Further, in cylindrical electrode 7, yttrium oxide exists not only in its surface layer portion but also in its inner part. Therefore, even if the yttrium oxide in the surface layer portion of cylindrical electrode 7 is exhausted by sputtering, the yttrium oxide in the inner part sequentially appears on the surface layer portion. Therefore, favorable starting performance is continued for a long period.

Next, the result of the test which was conducted for confirming the effect of the present invention is shown in Table 1. In this test, ten cold-cathode fluorescent lamps (test targets) which were the same as cold-cathode fluorescent lamp 1 of this example were prepared. Voltage was applied to each of cold-cathode fluorescent lamps in the dark space of 0.1 luxes or less, and the time from when the voltage was applied to the when the lamp was started up (starting time) was measured. Further, ten of the cold-cathode fluorescent lamps (comparison targets 1) including the nickel electrodes with cesium compound layers formed on their surfaces were prepared. Ten of the cold-cathode fluorescent lamps (comparison targets 2) including the simple nickel electrodes without a cesium compound layer formed thereon were prepared. The starting times of comparison targets 1 and 2 were measured under conditions similar to the above description.

TABLE 1

| | 1 | | 2 | | 3 | | 4 | | 5 | | 6 | | 7 | | 8 | | 9 | | 10 | |
|---|---|---|---|---|---|---|---|---|---|---|---|---|---|---|---|---|---|---|---|---|
| TEST | <13 | μs | <13 | μs | <13 | μs | <13 | μs | <13 | μs | <13 | μs | <13 | μs | <13 | μs | <13 | μs | <13 | μs |
| TARGET | | | | | | | | | | | | | | | | | | | | |
| COMPARISON | <13 | μs | <13 | μs | <13 | μs | <13 | μs | <13 | μs | <13 | μs | <13 | μs | <13 | μs | <13 | μs | <13 | μs |
| TARGET 1 | | | | | | | | | | | | | | | | | | | | |
| COMPARISON | 3731 | μs | >9999 | μs | 1989 | μs | 3473 | μs | >9999 | μs | >9999 | μs | 891 | μs | >9999 | μs | 1732 | μs | 4901 | μs |
| TARGET 2 | | | | | | | | | | | | | | | | | | | | |

As is obvious from Table 1, the starting performance of the cold-cathode fluorescent lamps of the present invention is remarkably improved as compared with the cold-cathode fluorescent lamps (comparison targets 2) having the nickel electrodes. Further, the cold-cathode fluorescent lamps of the present invention are improved in starting performance equivalently or more as compared with the cold-cathode fluorescent lamps (comparison targets 1) having the electrodes on which the cesium compound layers are formed. Further, yttrium oxide is dispersed uniformly inside cylindrical electrodes 7 which are included in the cold-cathode fluorescent lamps of the present invention, and therefore, the starting performance of the cold-cathode fluorescent lamp of the present invention which equivalent to or more than the starting performance of the cold-cathode fluorescent lamp of the comparison targets 1 continues for a long period.

Further, according to the above described test and the other tests, it was confirmed that the cold-cathode fluorescent lamp of the present invention provides the excellent effect concerning sputtering resistance.

Electrodes formed from a pure nickel or nickel base metal material have been used for the electrodes of the conventional discharge lamps. For example, electrodes formed from a nickel base metal material including a mixture ratio of, for example, 99.7 weight % of nickel, 0.1 weight % of manganese, 0.1 weight % of iron, and 0.1 weight % of impurities (carbon, silicon, copper and sulfur) have been used. The electrodes which are formed from pure nickel and nickel base metal materials include the following advantages. (1) They are easily welded to koval which is generally used as a sealer for hermetically sealing the end portions of the glass tube. (2) They include sufficient durability to withstand use under the condition of a tube current of 4.0 to 5.0 mA. (3) They are easily machined and low in cost.

However, with increases in screen size and luminance of liquid crystal display devices, cold-cathode fluorescent lamps are required resistance to a tube current of 5.0 mA or more. As the tube current increases, the load on the electrodes increases, and therefore, sputtering resistance of the electrodes needs to be improved. Thus, for the electrodes of the cold-cathode fluorescent lamps, high-melting point sintered metals such as molybdenum (Mo) and niobium (Nb) that are excellent in sputtering resistance as compared with nickel have come to be used. Meanwhile, the electrodes of high melting point sintered metal have a new problem in which they become oxidized at the time of being welded to the lead wires and at the time of being fitted to the glass tubes. Further, these electrodes include problems in which not only the material unit price is extremely high as compared with nickel but also machining is difficult and the cost is high.

Therefore, according to the present invention which realizes the electrodes that uses nickel as a main component and which are excellent in sputtering resistance, not only the above described problem concerning the starting performance of the cold-cathode fluorescent lamps, but also the above described problem concerning sputtering resistance are solved at the same time.

Table 2 shows the result of testing the sputtering resistance of cylindrical electrodes 7 and the starting performance of cold-cathode fluorescent lamps 1 by variously changing the amount (mixture ratio) of yttrium oxide included in cylindrical electrode 7 shown in FIG. 1. “GOOD” in Table 2 indicates that the test result was favorable. “MODERATE” indicates that the test result was moderate (about the same as the conventional one), and “POOR” indicates that the desired result was not obtained. The amounts (weight %) of yttrium oxide (YOx) shown in Table 2 indicate the added amounts of both yttrium oxide and yttrium when both yttrium oxide and yttrium were dispersed in cylindrical electrodes 7.

TABLE 2

| YOₓ | SPUTTERING | DARKNESS STARTING |
|---|---|---|
| (WEIGHT %) | RESISTANCE | PERFORMANCE |
| 0.01 | MODERATE | POOR |
| 0.02 | GOOD | MODERATE |
| 0.15 | GOOD | GOOD |
| 0.55 | GOOD | GOOD |
| 1.20 | GOOD | GOOD |
| 1.50 | MODERATE | GOOD |
| 1.60 | MODERATE | MODERATE |

From Table 2, it can be understood that the favorable results were obtained when the mixture ratio of yttrium oxide was within the range of 0.02 weight % to 1.50 weight %. Further, it can be understood that when the mixture ratio is within the range of 0.15 weight % to 1.20 weight %, both the sputtering resistance and starting performance are always favorable.

Here, as one example of yttrium oxide, yttria (Y2O3) is cited. However, yttrium oxide dispersed in the electrodes in the present invention is not limited to yttria. Further, yttrium is high in activity, and includes the property of being easily oxidized. Therefore, when mixing yttrium with nickel, it is convenient to mix it in the form of yttrium oxide. Of course, the electrodes may be formed by a metal material made by mixing metal yttrium (Y) and nickel. Further, the electrodes may be formed by a metal material made by mixing yttrium oxide, yttrium and nickel. In the process of mixing yttrium and nickel to produce a metal material and in the other processes, yttrium sometimes changes into yttrium oxide. In this case, both yttrium and yttrium oxide are also dispersed in the electrode formed by the produced metal material. In short, when yttrium oxide is dispersed in the electrode, the yttrium oxide may be the one mixed with nickel in the form of yttrium oxide, or may be the yttrium oxide that is formed in the process for producing the metal material or that is formed in the other processes.

The composition of the electrode is not limited to the above described composition. For example, it may be a composition that has a mixture ratio of, for example, 97.35 weight % of nickel (including 0.01% or less of cobalt), 0.55 weight % of yttrium or yttrium oxide, 2.0 weight % of manganese, and 0.1 weight % of impurities (carbon, silicon, copper, sulfur, magnesium and iron).

Further, the shape of the electrode is not limited to the above described cylinder shape, but may be in a plate-shape, a columnar shape and other desired shapes.

### Exemplary Embodiment 2

Next, another example of an exemplary embodiment of the cold-cathode fluorescent lamp of the present invention will be described. The cold-cathode fluorescent lamp of this exemplary embodiment and the cold-cathode fluorescent lamp of exemplary embodiment 1 differ from each other only in the composition of the cylindrical electrodes configuring the electrode units. Thus, only the composition of the cylindrical electrode will be described hereinafter, and description of the same components as exemplary embodiment 1 will be omitted.

In the cylindrical electrode which is included in the cold-cathode fluorescent lamp of this example, a metal that has a deoxidizing action (titanium (Ti) in this example) is dispersed in addition to either yttrium or yttrium oxide, or both. More specifically, the cylindrical electrode included by the cold-cathode fluorescent lamp of this example is made of a metal material that has a mixture ratio of 99.35 weight % of nickel (including 0.01% or less of cobalt), 0.55 weight % of yttrium or yttrium oxide, 0.05 weight % of titanium, and 0.05 weight % of impurities (carbon, silicon, copper, sulfur, magnesium and iron), and has a composition substantially similar to the metal material.

By dispersing metal that has the deoxidizing action, starting performance in the dark space is further improved. The reason is that part of oxidized yttrium is reduced by the metal that has the deoxidizing action. It has been also confirmed that sputtering resistance is improved by the metal including the deoxidizing action.

As the metal including the deoxidizing action, manganese (Mn), zirconium (Zr) or hafnium (Hf) is cited in addition to titanium. Table 3 shows the result of testing the sputtering resistance of the cylindrical electrodes and the starting performance of the cold-cathode fluorescent lamps by setting the mixture ratio of yttrium oxide to be constant and by variously changing the kind and mixture ratio of the metal including deoxidizing action. “EXCELLENT” in Table 3 indicates that the test result was extremely favorable, Similarly, “GOOD” indicates that the test result was favorable, “MODERATE” indicates moderate (about the same as the conventional one), and “POOR” indicates that the desired result was not obtained, respectively. When both yttrium oxide and yttrium are dispersed in cylindrical electrodes 7, the amount (weight %) of yttrium oxide (YOx) shown in Table 3 indicates the added amount of both of them.

TABLE 3

| | | | | | DARKNESS |
|---|---|---|---|---|---|
| YOₓ | Mn | Ti | Zr | SPUTTERING | STARTING |
| (WEIGHT %) | (WEIGHT %) | (WEIGHT %) | (WEIGHT %) | RESISTANCE | PERFORMANCE |
| 0.55 | 1.00 | | | MODERATE | GOOD |
| 0.55 | 1.10 | | | GOOD | EXCELLENT |
| 0.55 | 2.00 | | | EXCELLENT | EXCELLENT |
| 0.55 | 4.00 | | | GOOD | EXCELLENT |
| 0.55 | 4.20 | | | MODERATE | GOOD |
| 0.55 | 0.70 | 0.007 | | MODERATE | GOOD |
| 0.55 | | 0.009 | | GOOD | GOOD |
| 0.55 | | 0.050 | | EXCELLENT | EXCELLENT |
| 0.55 | | 0.800 | | GOOD | EXCELLENT |
| 0.55 | | 0.900 | | MODERATE | GOOD |
| 0.55 | | | 0.04 | MODERATE | GOOD |
| 0.55 | | | 0.05 | GOOD | GOOD |
| 0.55 | | | 0.50 | EXCELLENT | EXCELLENT |
| 0.55 | | | 1.10 | EXCELLENT | EXCELLENT |
| 0.55 | | | 1.20 | MODERATE | GOOD |

### Exemplary Embodiment 3

Next, another example of an exemplary embodiment of the cold-cathode fluorescent lamp of the present invention will be described. The cold-cathode fluorescent lamp of this exemplary embodiment differs from the cold-cathode fluorescent lamps of exemplary embodiments 1 and 2 only in the structure of the lead wire configuring the electrode unit. Thus, only the structure of the lead wire will be described hereinafter, and description of the same components as those in exemplary embodiments 1 and 2 will be omitted.

As shown in FIG. 3, lead wire 9b of this example includes a multilayer structure (two-layer structure) in which inside part 32 formed from copper (Cu) or a copper alloy is provided inside an outside part 33 formed from koval. Inside part 32 is provided for dissipation of the heat that is mainly generated from the electrode. Dumet 34 formed by coating the periphery of a nickel iron alloy with copper is joined to the rear end of lead wire 9b. Lead wire 9b is connected to a power source device (not illustrated) via Dumet 34.

Cylindrical electrode 7 shown in FIG. 3 is formed by the same metal material as the metal material described in exemplary embodiment 1 or 2. Therefore, the starting performance and the sputtering resistance of the cold-cathode fluorescent lamp of this example are totally similar to those in the cold-cathode fluorescent lamp of exemplary embodiment 1 or 2. The melting point of cylindrical electrode 7 is substantially the same as the melting point of nickel. Therefore, excessively high temperature is not required for joining cylindrical electrode 7 and lead wire 9b. Accordingly, there is an extremely low possibility that inside part 32 of lead wire 9b will be excessively heated by the heat at the time of welding and that copper or a copper alloy will be blown off to the outside.

The selected exemplary embodiments of the present invention are described by using specific terms, but the descriptions are intended only for examples, and it is to be understood that changes and modifications are possible without departing from the spirit and scope of the following claims.

1-18. (canceled)

19. An electrode used for a cold-cathode fluorescent lamp, wherein nickel (Ni) is a main component, and yttrium (Y) is dispersed.

20. An electrode used for a cold-cathode fluorescent lamp, wherein nickel (Ni) is a main component, and yttrium oxide (YOx) is dispersed.

21. An electrode used for a cold-cathode fluorescent lamp, wherein nickel (Ni) is a main component, and yttrium (Y) and yttrium oxide (YOx) are dispersed.

22. The electrode according to claim 19, wherein a metal that has a deoxidizing action is further dispersed.

23. The electrode according to claim 20, wherein a metal that has a deoxidizing action is further dispersed.

24. The electrode according to claim 21, wherein a metal that has a deoxidizing action is further dispersed.

25. The electrode according to claim 22, wherein said metal that has the deoxidizing action is any one among the following, titanium (Ti), manganese (Mn), zirconium (Zr) and hafnium (Hf).

26. The electrode according to claim 23, wherein said metal that has the deoxidizing action is any one among the following, titanium (Ti), manganese (Mn), zirconium (Zr) and hafnium (Hf).

27. The electrode according to claim 24, wherein said metal that has the deoxidizing action is any one among the following, titanium (Ti), manganese (Mn), zirconium (Zr) and hafnium (Hf).

28. A method for producing an electrode, comprising:
melting yttrium (Y) and nickel (Ni) to obtain a nickel base metal material in which yttrium is dispersed; and
machining said metal material into a desired shape.

29. A method for producing an electrode, comprising:
melting yttrium oxide (YOx) and nickel (Ni) to obtain a nickel base metal material in which yttrium oxide is dispersed; and
machining said metal material into a desired shape.

30. A method for producing an electrode, comprising:
melting yttrium (Y), nickel (Ni) and a metal that has a deoxidizing action to obtain a nickel base metal material in which yttrium and the metal that has the deoxidizing action are dispersed; and
machining said metal material into a desired shape.

31. A method for producing an electrode, comprising:
melting yttrium (Y), yttrium oxide (YOx), nickel (Ni) and a metal that has a deoxidizing action to obtain a nickel base metal material in which yttrium, yttrium oxide and the metal that has the deoxidizing action are dispersed; and
machining said metal material into a desired shape.

32. A cold-cathode fluorescent lamp comprising a glass tube having hermetically sealed internal space, rare gas and mercury gas sealed inside said internal space of said glass tube, and a phosphor layer formed on an inner wall surface of said glass tube,
wherein the electrodes according to claim 19 are disposed in states opposite to each other, inside said internal space of said glass tube.

33. A cold-cathode fluorescent lamp comprising a glass tube having hermetically sealed internal space, rare gas and mercury gas sealed inside said internal space of said glass tube, and a phosphor layer formed on an inner wall surface of said glass tube,
wherein the electrodes according to claim 20 are disposed in states opposite to each other, inside said internal space of said glass tube.

34. A cold-cathode fluorescent lamp comprising a glass tube having hermetically sealed internal space, rare gas and mercury gas sealed inside said internal space of said glass tube, and a phosphor layer formed on an inner wall surface of said glass tube,
wherein the electrodes according to claim 21 are disposed in states opposite to each other, inside said internal space of said glass tube.
